(19) United States
(12) Patent Application Publication
(10) Pub. No.: US 2025/0164784 A1
(43) Pub. Date: May 22, 2025

(54) WAVEFRONT MANIPULATOR WITH TOTAL REFLECTION AND REFLECTION HOLOGRAM

(71) Applicant: Carl Zeiss Jena GmbH, Jena (DE)

(72) Inventors: Siemen KUEHL, Jena (DE); Yi ZHONG-SCHIPP, Jena (DE)

(21) Appl. No.: 18/843,625

(22) PCT Filed: Feb. 23, 2023
(86) PCT No.: PCT/EP2023/054538

§ 371 Date: Sep. 3, 2024

(30) Foreign Application Priority Data
Mar. 3, 2022 (DE) 10 2022 105 038.6

(51) Int. Cl. G02B 27/01; G02B 5/04; G02B 5/32; G02B 6/34

(52) U.S. Cl. CPC G02B 27/0103; G02B 5/045; G02B 5/32; G02B 6/34; G02B 2027/011

(57) ABSTRACT

A wavefront manipulator which comprises a holographic assembly and an optical element is provided. The optical element includes at least one surface, which is totally reflective for an ascertained range of incidence angles, for emitting light waves onto the holographic assembly. The holographic assembly includes at least one reflection hologram for reflecting light waves emitted onto the holographic assembly via the optical element. The optical element includes a coupling device for coupling light waves into the wavefront manipulator. The coupling device includes at least one prism.

### PRIORITY

This application claims the benefit of German Patent Application No. 10 2022 105 038.6 filed on Mar. 3, 2022, which is hereby incorporated herein by reference in its entirety.

### FIELD

The present invention relates to a wavefront manipulator, for example for arrangement in the beam path of a head-up display (HUD) between a projection lens and a projection surface, in particular a curved projection surface. The invention furthermore relates to an optical arrangement and to a head-up display.

### BACKGROUND

Head-up displays are now being used in the context of diverse applications, inter alia also in association with observation windows of vehicles, for example on windshields of motor vehicles, front screens or observation windows of aircraft. These viewing windows, and in particular windshields, usually have a curved surface which is used as a projection surface of head-up displays.

A head-up display usually comprises a picture generating unit (PGU) or a projector, a projection surface, an eyebox and an image plane of the virtual image representation. An image representation is created by means of the picture generating unit or the projector. The image representation is projected onto the projection surface and is projected from the projection surface into the eyebox. The eyebox is a plane or a spatial region in which the projected image representation is perceptible to a viewer as a virtual image. The image plane of the virtual image representation, i.e. the plane on or in which the virtual image is created, is arranged on or behind the projection surface.

Imaging aberrations, or aberrations, occur as a result of the curvature of the projection surface and as a result of compact arrangements in a small installation space with, under certain circumstances, severe tilting of individual components with respect to one another and correspondingly complexly folded beam paths. A windshield can generally be described as an optical freeform face. If a head-up display is used in association with a curved windshield or a curved observation window, then it is desirable to correct imaging aberrations that occur as a result of the curvature, the abovementioned imaging aberrations that occur for reasons of structural space, under certain circumstances, and imaging aberrations caused by the picture generating unit, if appropriate, in the optical beam path. The imaging aberrations, or aberrations, which can occur in this case are, for example, distortion, defocus, tilting, astigmatism, curvature of the image plane, spherical aberrations, higher astigmatism and coma. Moreover, the largest possible field of view, the largest possible eyebox and also a uniform, bright and multicolored image representation, preferably multicolored at each image point, are desirable in association with head-up displays, in particular for vehicle applications. Corresponding demands should also be met in conjunction with other optical applications and should be implemented by way of suitable wavefront manipulators.

Documents DE 10 2007 022 247 A1, DE 10 2015 101 687 A1, DE 10 2017 212 451 A1 and DE 10 2017 222 621 A1 describe holographic imaging optics for head-up displays, especially in the context of windshields. In the context of head-up displays and other optical applications, the desire for high imaging quality is often complemented by the desire for the utilized components to be fixedly installed or arranged fixed in relation to one another, in particular in order to reduce costs and maintain system stability.

The documents JP 2020-34 602 A and JP 2008-158203 A disclose head-up displays for motor vehicles. The document US 2006/0 132 914 A1 describes displaying an image representation against a background, in particular in the context of a head-mounted display.

### SUMMARY

An object herein is to provide an advantageous wavefront manipulator. Further objects include providing an advantageous optical arrangement and also an advantageous head-up display.

The wavefront manipulator in certain example embodiments comprises a holographic arrangement and an optical element, for example a waveguide. For radiating light waves onto the holographic arrangement, the optical element comprises at least one face providing total-internal reflection for a defined angle of incidence range. The face providing total-internal reflection can be a surface. The holographic arrangement comprises at least one reflection hologram for reflecting light waves radiated onto the holographic arrangement by means of the optical element. The optical element comprises an input coupling device serving to input couple light waves into the wavefront manipulator, in particular in the direction of the face providing total-internal reflection. The input coupling device comprises at least one prism.

By preference, the prism is formed as a component separate from the optical element, in particular the waveguide. The prism can be arranged directly on the optical element and/or directly on the holographic arrangement. Advantageously, the interface between the prism and the optical element and/or the holographic arrangement has no jump in refractive index in this variant. At least a change in refractive index at the interface should be as small as possible, for example be less than 0.1, preferably less than 0.05.

The optical element, in particular the waveguide, can have a top side and an underside which are embodied for total-internal reflection of light waves therebetween. The top side and the underside can be connected to one another by way of side faces. The prism is preferably arranged on the top side or on the underside, i.e., in other words, not on one of the side faces. In the case of a one-piece configuration of optical element, in particular waveguide, and prism, i.e. a configuration in which the prism is an integral constituent part of the optical element, in particular of the waveguide, the prism can be arranged or formed such that it projects from the respective side at the top side or the underside, i.e. geometrically protrudes from the top side or the underside. In comparison with input coupling on one of the side faces, an enlarged input coupling surface and larger angular range for input coupling is realizable by the described configurations.

The wavefront manipulator is advantageous in that it allows the use of reflection holograms with a reduced number of holograms required to this end. Usually, transmitting holographic components using reflection holograms are realized by two reflection holograms arranged one behind the other (so-called z-holograms), with the individual holograms being efficient for a specific wavelength. Accordingly, 6 holograms are required for a multicolored application, for example by means of wavelengths from three colors or wavelengths of a defined color space (e.g. RGB applications). In this case, the integration of the holograms to form a hologram stack is generally very complicated. As a result of the very complex stack structure and the use of a plurality of holograms, the transmittance is significantly reduced, inter alia as a result of material absorption. Moreover, the holograms can filter one another. To overcome these disadvantages, the wavefront manipulator allows a reduction in the number of holograms without impairing the functionality of the wavefront manipulator. Instead, an improved functionality is obtained as a result of the reduced filter effects.

A beam deflection conventionally attained by a reflection hologram is realized by means of the face of the optical element providing total-internal reflection. As a result of arranging the optical element in the beam path such that, by way of the optical element, light having undergone total-internal reflection is radiated into the holographic arrangement for reflection by same, which allows half of the holograms required otherwise to be economized by exploiting total-internal reflection. The costs are significantly reduced in the process. Moreover, possible filter effects and aberrations are reduced as a result of the smaller number of components. Preferably, at least one of the holograms, in particular a plurality of the holograms or all holograms, is designed for aberration correction. To this end, at least one of the holograms can be recorded or written using freeform design wavefronts, i.e. using light waves whose wavefronts form freeform areas.

The holographic arrangement is designed such that it efficiently diffracts a wave which is subject to total-internal reflection before the incidence of same on the hologram. By preference, at least one hologram is designed such that, within the scope of a reconstruction with the exposure wavelength, it is efficient for at least one angle greater than the limit angle of total-internal reflection for the face of the optical element providing total-internal reflection.

Advantageously, the holographic arrangement is arranged in the beam path downstream of the optical element. Alternatively, the holographic arrangement can be arranged in the beam path in such a way that it transmits light waves in the beam path immediately downstream of the input coupling device, i.e. prior to a first total-internal reflection and/or prior to a second total-internal reflection within the optical element, and reflects light waves in the beam path behind the face providing total-internal reflection. In other words, the holographic arrangement may be arranged geometrically and in the beam path between the input coupling device and the face providing total-internal reflection, but as an element which only transmits light waves in this beam direction, without having diffraction efficiency. Optionally, light waves, following the first total-internal reflection, can pass through the holographic arrangement again, preferably in the direction of a face, in particular a reflective face, of the prism, for example designed for aberration correction, and can reflect at the face providing total-internal reflection only after a second total-internal reflection. The face of the prism designed for aberration correction can be formed as a freeform face and/or comprise at least one hologram. This configuration offers the advantages of installation space reduction and improved correction of imaging aberrations.

By preference, the wavefront manipulator is designed as transmission component, in particular with refractive power. Thus this provides the advantages of a reflection hologram with a number of holograms reduced by half. Previously, two holograms were required for one wavelength for a transmission component with reflection holograms.

The input coupling device can comprise a plurality of prisms. The prisms can be arranged in a row or as a grid on an input coupling surface. For example, they can be formed as a prism array, in particular as a microprism array. The dimensions of the individual prisms can be in the micrometer range. The lateral or perpendicular extent of the individual prisms can be between 5 micrometers and 1 millimeter, for example between 5 μm and 50 μm, between 50 μm and 200 μm, between 200 μm and 500 μm or between 500 μm and 1 mm. The use of a plurality of prisms is advantageous in that the individual prisms can be designed in wavelength-specific and/or angle of incidence-specific fashion and can thus contribute firstly to beam expansion and secondly to aberration correction. Moreover, for example the faces and/or elements of the prism can be designed for aberration correction, in particular in transmission and/or reflection. To this end, at least one face arranged in the beam path and/or one element of the prism can be formed as a freeform face. Furthermore, a plurality of faces and/or elements of the prism can interact for aberration correction. Advantageously, the prism and the holographic arrangement can be designed such that they interact for aberration correction. For example, the input coupling face and/or a reflective element of the prism and/or the holographic arrangement can be formed to interact for aberration correction.

The optical element can comprise a first side, e.g. in the form of a top side, and a second side, e.g. in the form of an underside, opposite the first side. The input coupling device and the holographic arrangement can be arranged on the first side. The face providing total-internal reflection can be arranged on the second side. A very compact arrangement can be realized as a result, which only requires total-internal reflection within the optical element for the purpose of deflecting the beam in the direction of the holographic arrangement. On account of the at least one prism, the surfaces of the first side (top side) and the second side (underside) do not extend parallel to one another in the region of the input coupling device.

In the case of a configuration as transmission element, the input coupling device and an input coupling region formed thereby and an output coupling region, which is designed to output couple light waves from the wavefront manipulator, are arranged on opposite sides of the wavefront manipulator.

Otherwise the input and output coupling regions can also be arranged on the same side. By preference, the face providing total-internal reflection comprises an output coupling region. Thus, the face providing total-internal reflection forms, at least in part, an output coupling face for light waves diffracted at the holographic arrangement.

In a further variant, the wavefront manipulator can comprise an output coupling region which at least in part encompasses the face providing total-internal reflection, the input coupling device and the output coupling region overlapping at least in part in a direction perpendicular to a surface normal of the face providing total-internal reflection.

The optical element can comprise glass or plastic. It can comprise at least one of the following materials: polycarbonate (PC), polymethylmethacrylate (PMMA), cyclic olefin polymer (COP), cycloolefin copolymers (COC), triacetate (TAC), an optically clear adhesive (OCA), borosilicate glass, one or more of the glass types B270, N-BK7, N-SF2, P-SF68, P-SK57Q1, P-SK58A and P-BK7, or comparable glasses. These materials are particularly well suited to a transparent optical waveguide which has good optical properties such as high transparency, homogeneity, for example in regard to the refractive index, and at the same time is inexpensive and easy to produce. The materials mentioned have in some instances a high refractive index in comparison with the surroundings, for example in comparison with air under standard conditions.

The optical element can be designed, in particular geometrically, such that light waves experience or undergo a fixed number n of total-internal reflections within the optical element between the input coupling device and the holographic arrangement. By preference, n is less than 5 (n<5), and equal to 1 in the best case scenario (n=1).

In an advantageous variant, the holographic arrangement comprises at least one reflection hologram which is designed to reflect a plurality of wavelengths or frequencies, i.e., in particular, light in a defined color space or for multicolored image representations, and is diffraction-efficient therefor (multiplex hologram). In an alternative, the holographic arrangement can comprise a plurality of reflection holograms which are designed, i.e. efficient, in each case for at least one wavelength or frequency, in particular a defined wavelength or frequency range, of light of a color in a color space. The color space can be, for example, an RGB color space (RGB-Red Green Blue) or a CMY color space (CMY-Cyan Magenta Yellow).

The individual holograms can be arranged as hologram stack. The aforementioned holograms are each designed, i.e. efficient, for at least one defined angle of incidence range. The holographic arrangement can be arranged immediately on the optical element or integrated in the optical element. For example, the holographic arrangement can comprise at least one reflection hologram which is arranged on a face of the optical element opposite the face providing total-internal reflection and which reflects light waves at an angle of incidence greater than the limit angle for total-internal reflection of the face providing total-internal reflection.

The at least one prism can comprise an input coupling face serving to input couple light waves into the prism and configured as a plane face or curved face or aspherical face or as a freeform face. This is advantageous in that a stationary arrangement of the individual components is ensured, i.e. there is no need for further adjustment, and so a susceptibility to errors within the scope of assembly is reduced.

In a further variant, the wavefront manipulator can comprise a further optical element. The further optical element can be a constituent part of the at least one prism or be arranged freestanding in the beam path. It can be configured to be transmissive or reflective, e.g. as a freeform mirror. The at least one prism can comprise an input coupling face for input coupling light waves into the prism, and the further optical element can be formed as a reflection layer on a face of the prism in the beam path between the input coupling face of the prism and the face providing total-internal reflection.

By preference, the optical element, the holographic arrangement and the at least one prism are formed in one piece as a monolithic component or are securely connected to one another to form a component. The fixed geometric arrangement of the individual components in relation to one another obtained thereby has the advantages already mentioned.

The wavefront manipulator can be designed for a head-up display, in particular for arrangement in the beam path between a picture generating unit and a projection area. Further application options are in the field of smartglasses, cameras and projectors.

The optical arrangement, e.g. for a head-up display on a projection surface, comprises in an example embodiment a picture generating unit and a wavefront manipulator described above. The picture generating unit can be arranged immediately on a face of the at least one prism. The picture generating unit advantageously comprises an object plane, i.e. is spatially extended, the object plane being designed to emit light in a defined emission angle range and with a defined maximum bandwidth with regard to the wavelengths of the emitted light. Preferably, the picture generating unit is designed for creating a multicolored image representation.

For example, each light-emitting point of the object plane emits light in the form of a scattering lobe or in a defined angular range. This can be achieved for example by the use of a diffuser. Preferably, the picture generating unit is designed to emit laser light, in particular laser beams. Advantageously, the picture generating unit is designed to emit laser light in at least two, preferably at least three, different waves. That preferably involves three different wavelengths of a defined color space, for example red, green and blue or cyan, magenta and yellow. Since the holographic elements are more sensitive with regard to the bandwidth of each wavelength compared with other optical components, such as mirrors and lens elements, for example, it is advantageous if the picture generating unit is configured as a laser scanner having a sharp bandwidth for each color.

The optical arrangement preferably has a volume of less than 10 liters, that is to say in other words occupies an installation space of less than 10 liters. The optical arrangement according to the invention has the features and advantages already mentioned above in connection with the wavefront manipulator. It offers in particular a very compactly fashioned arrangement, which i.e. occupies just a small installation space, and at the same time ensures a very high imaging quality.

Both the wavefront manipulator and the optical arrangement according to the invention are suitable for retrofitting in the context of head-up displays in for example motor vehicles, aircraft or VR arrangements, for example VR glasses.

The head-up display in an example embodiment comprises a projection surface and an optical arrangement as described herein. The e.g. curved projection surface can be a windshield of a vehicle, for example of a motor vehicle, of an aircraft or of a ship. However, the projection surface can also be some other observation window, for example an observation window of VR glasses. The curved projection surface can be regarded as a freeform face, for example. Imaging aberrations, or aberrations, that are caused thereby are compensated for by means of the wavefront manipulator, and a tilted image plane of a virtual image representation is moreover created.

The invention is explained in greater detail below on the basis of exemplary embodiments with reference to the accompanying figures. Although the invention is more specifically illustrated and described in detail by means of the preferred exemplary embodiments, nevertheless the invention is not restricted by the examples disclosed and other variations can be derived therefrom by a person skilled in the art, without departing from the scope of protection of the invention.

The figures are not necessarily accurate in every detail and to scale, and can be presented in enlarged or reduced form for the purpose of better clarity. For this reason, functional details disclosed here should not be understood to be limiting, but merely to be an illustrative basis that gives guidance to a person skilled in this technical field for using the present invention in various ways.

The expression “and/or” used here, when it is used in a series of two or more elements, means that any of the elements listed can be used alone, or any combination of two or more of the elements listed can be used. For example, if a structure is described containing the components A, B and/or C, the structure can contain A alone; B alone; C alone; A and B in combination; A and C in combination; B and C in combination; or A, B, and C in combination.

### BRIEF DESCRIPTION OF THE DRAWINGS

FIG. 1 schematically shows the beam path through a wavefront manipulator according to certain example embodiments of the invention in a side view.

FIG. 2 schematically shows a head-up display according to certain example embodiments of the invention with a wavefront manipulator.

FIG. 3 schematically shows a head-up display according to certain example embodiments of the invention with a wavefront manipulator.

FIG. 4 schematically shows a head-up display according to certain example embodiments of the invention with a wavefront manipulator.

FIG. 5 schematically shows a head-up display according to certain example embodiments of the invention with a wavefront manipulator.

FIG. 6 schematically shows a head-up display according to certain example embodiments of the invention with a wavefront manipulator.

FIG. 7 schematically shows a head-up display according to certain example embodiments of the invention with a wavefront manipulator.

FIG. 8 schematically shows a head-up display according to certain example embodiments of the invention with a wavefront manipulator.

FIG. 9 schematically shows a head-up display according to certain example embodiments of the invention with a wavefront manipulator.

FIG. 10 schematically shows a head-up display according to certain example embodiments of the invention with a wavefront manipulator.

FIG. 11 schematically shows a head-up display according to certain example embodiments of the invention with a wavefront manipulator.

FIG. 12 schematically shows an optical arrangement according to certain example embodiments of the invention with a wavefront manipulator in the form of a block diagram.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

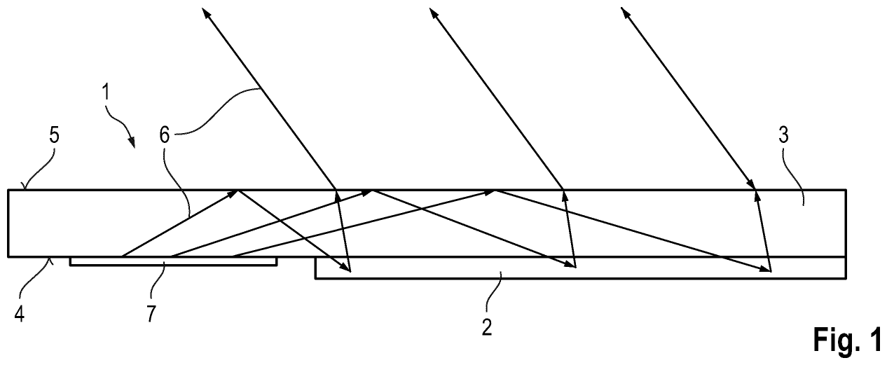

FIG. 1 schematically shows the beam path through a wavefront manipulator in a side view. The wavefront manipulator 1 comprises a holographic arrangement 2 and an optical element 3. The optical element 3 comprises a first side 4, which forms the underside in the figure shown, and a second side 5, which forms the top side in the figure shown. In the variant shown, the holographic arrangement 2 is arranged on the first side 4, i.e. the underside. The optical element 3 comprises an input coupling device 7 in the region in which light beams 6 are input coupled into the optical element 3 on the first side 4. The input coupling device 7 not shown in detail in FIG. 1 comprises at least a prism and is formed such that it allows input coupling of the light 6 at an angle such that the input-coupled light beams can undergo total-internal reflection at the second side 5 of the optical element 3.

The holographic arrangement 2 is arranged next to the input coupling device 7 in FIG. 1. The light beams 6 undergoing total-internal reflection at the second side 5 are incident on the holographic arrangement 2 at an angle of incidence for which the holographic arrangement 2 is diffraction-efficient. The holographic arrangement 2 comprises at least one reflection hologram. The light reflected or diffracted by the holographic arrangement 2 is refracted at the second side 5 of the optical element 2 and output coupled from the wavefront manipulator 1. The second side 5 thus comprises an output coupling region. The wavefront manipulator thus is designed as a transmission component with refractive power. The holographic arrangement 2 comprises at least one hologram which is diffraction-efficient for at least one defined angle in the case of an exposure at the exposure wavelength thereof, the defined angle being greater than the limit angle of total-internal reflection for the optical element 3.

The holographic arrangement 2 can comprise at least one hologram that is diffraction-efficient for a plurality of wavelengths in a defined color space. The holographic arrangement 2 can also comprise a plurality of holograms which are each diffraction-efficient for at least one wavelength in a defined color space and at least one defined angle of incidence range. The plurality of holograms can be arranged next to one another or in the form of a hologram stack, i.e. as a stack on one another.

In comparison with conventional hologram arrangements formed from reflection holograms, the wavefront manipulator 1 is advantageous in that only half the number of holograms is required in order to be able to use the advantages of reflection holograms. This reduces costs and improves the accuracy at the same time since imaging aberrations that may arise due to the arrangement of the holograms on one another are avoided.

In principle, the optical element 3 can be formed as a substrate or waveguide. However, an additional substrate can also be present, and the optical element 3 can be formed as a film or layer. In principle, the optical element 3 can comprise glass or plastic or consist of these materials. In this context, the material of the optical element can comprise at least one of the materials already listed above.

The zeroth order of diffraction, which tends to be undesired and forms stray light, remains in the optical element 3 and/or an additional substrate on account of the total-internal reflection and can be suitably guided to a side face or an edge into a beam trap (beam dump). This is particularly advantageous since the light of the zeroth order is generally not used and accordingly represents stray light.

In principle, the wavefront manipulator shown in FIG. 1 can find use in a head-up display, for example. This application is used below for various exemplary embodiments. This does not preclude other applications for example in other optical arrangements or optical systems.

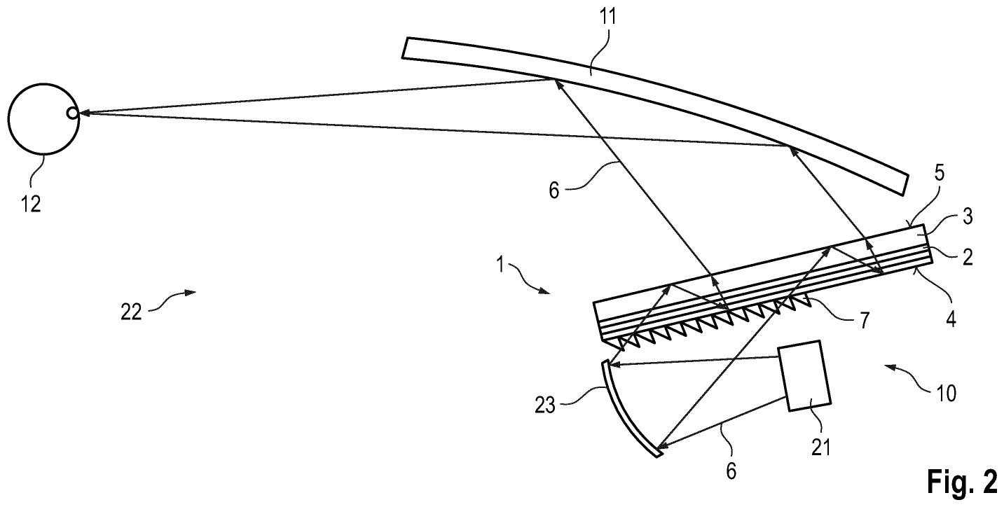

FIG. 2 schematically shows a head-up display. The head-up display 22 comprises an optical arrangement 10 and a projection area in the form of a windshield 11. An observer or an eye box 12 identify the region from which a virtual image representation projected by the head-up display 22 behind the projection area 11 is perceivable by an observer.

The optical arrangement 10 comprises a picture generating unit 21 and a wavefront manipulator 1. In addition to the wavefront manipulator 1 already described with regards to its basic structure on the basis of FIG. 1, the wavefront manipulator 1 comprises a further optical element 23 arranged in the beam path between the picture generating unit 21 and the input coupling device 7. The further optical element 23 is configured as a freeform mirror in the variant shown. It is designed for beam deflection and aberration correction. Further aberration corrections can be implemented by means of the prisms of the input coupling device 7 and the holographic arrangement 2.

In the variant shown, the input coupling device 7 is configured as an arrangement of a plurality of prisms, in particular as a microprism arrangement. In this case, the prisms bring about input coupling of light waves on the first side 4 of the optical element 2 at an angle enabling total-internal reflection on the second side 5. In contrast to the variant shown in FIG. 1, the holographic arrangement 2 is integrated in the optical element 3 and extends over, or forms, the entire first side 4.

Light coming from the further optical element 23, which coming from the picture generating unit 21 was previously reflected at the further optical element 23, is input coupled into the optical element 3 in the direction of the second side 5 via the input coupling device 7, i.e. the microprism array. In this case, the light is initially transmitted through the holographic arrangement 2, by preference without filtering effects arising in the process. Since the holographic arrangement 2 is designed as a reflection hologram and is only diffraction-efficient in reflection for light coming from the direction of the second side 5, diffraction does not yet occur during the transmission but only arises for light coming from the second side 5. The light diffracted by the holographic arrangement 2 is subsequently incident on the second side 5, where it is refracted and output coupled from the wavefront manipulator in the direction of the projection surface 11, for example the windshield.

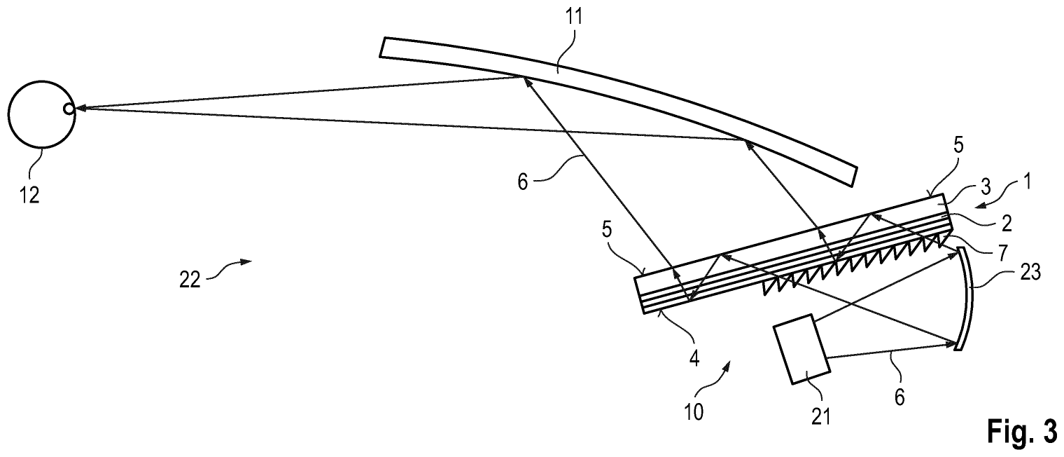

The alternative variant shown in FIG. 3 differs from the variant shown in FIG. 2 merely in terms of the direction of the arrangement of the input coupling device 7, the further optical element 23 and the picture generating unit 1 in relation to the projection area 11. The arrangement is mirror symmetric with respect to the variant shown in FIG. 2. While the picture generating unit 1 in FIG. 2 emits light to the left and the input coupling device is arranged in the left-hand region of the first side 4, the picture generating unit 21 in FIG. 3 emits light to the right in the direction of the further optical element 23, arranged to the right in this variant, and is emitted by the latter in the direction of an input coupling device 7 arranged in the right-hand region of the first side 4.

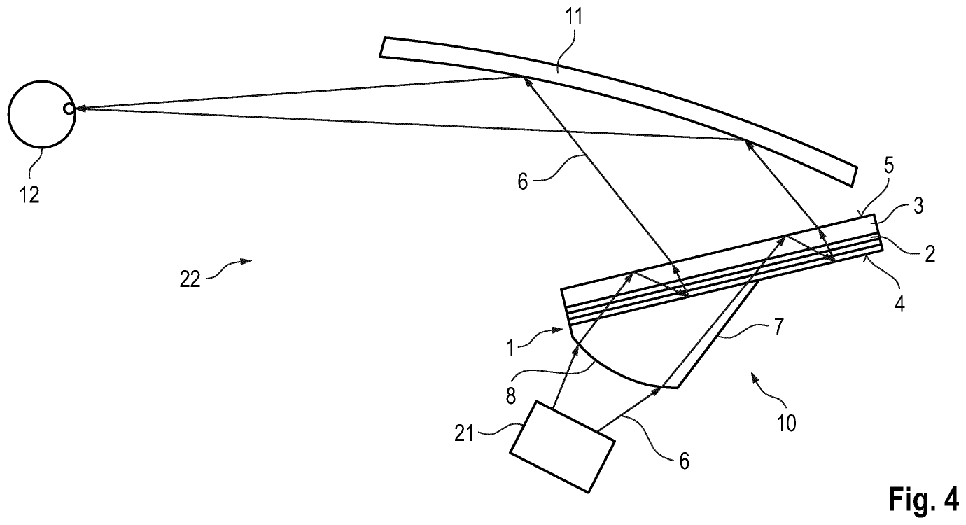

FIGS. 4 to 9 show three further embodiment variants, each in two alternatives, in which a monolithic or a single prism is used as an input coupling device 7 in place of a plurality of prisms. In all embodiment variants shown, the optical element 3 is formed as a monolithic component, i.e. in one piece, with the input coupling device 7 and the holographic arrangement 2. In an alternative, the aforementioned component parts can be securely connected to one another. However, a monolithic configuration is advantageous in that a precise arrangement of the aforementioned component parts with respect to one another can be ensured within the scope of production, and so these component parts are robust in view of their further installation within the scope of an optical component or an optical arrangement. No further adjustment is required and there are no additional manufacturing-related aberrations.

In the variant shown in FIG. 4, a prism 7 is arranged on the first side 4 or in a manner encompassed by the latter. The prism 7 comprises an input coupling face 8. The input coupling face 8 is designed to input couple light, for example from a picture generating unit 21, into the wavefront manipulator 1. To this end, the input coupling face 8 is preferably formed as a transmissively designed freeform face. Aberrations can be corrected by means of the freeform face 8. The input coupling face 8 can be curved, more particularly convexly curved. After passing through the prism 7, light input coupled by the input coupling face 8 passes through the holographic arrangement 2, undergoes total-internal reflection at the second side 5 of the optical element 3 and is subsequently diffracted by the holographic arrangement 2 in the direction of the second side 5, as already explained on the basis of FIGS. 1-3.

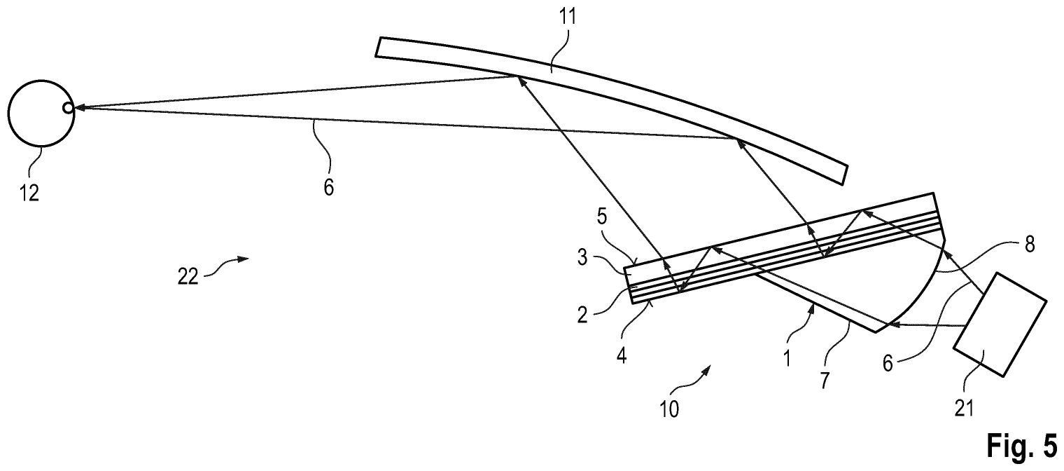

The variant shown in FIG. 5 differs from the variant shown in FIG. 4 merely in terms of the geometric arrangement of the prism 7 and the picture generating unit 21, i.e. the optical arrangement 1, in relation to the projection area 11. While the picture generating unit 21 and the prism 7 are arranged to the left below the holographic arrangement 2 in FIG. 4, the prism 7 and the picture generating unit 21 are arranged to the right below the holographic arrangement 2 in FIG. 5.

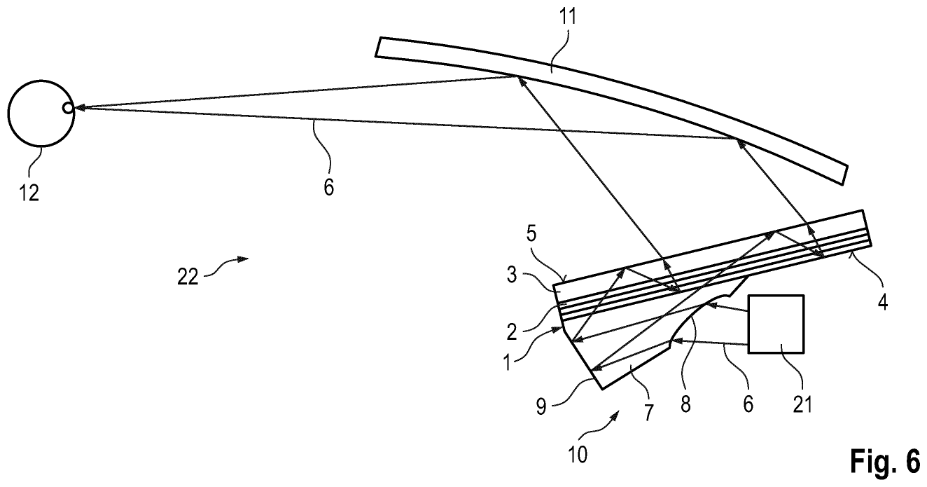

In the variant shown in FIG. 6, the prism 7 comprises a reflective element 9 in the form of a reflection layer 9 in addition to a curved input coupling face 8, for example an input coupling face configured as a freeform face. The reflection layer 9 can be formed as an optical element arranged directly on a face of the prism 7 or can be integrated in the prism 7. The reflective element 9 can have a planar form, i.e. embodied as a plane reflective face or as a freeform face. The input coupling face 8 and the reflective face 9 are arranged relative to one another on the prism 7 such that light input coupled by the input coupling face 8 is reflected at the reflective face 9 such that it is transmitted through the holographic arrangement 2 in the direction of the second side 5 at an angle of incidence that is greater than the limit angle of total-internal reflection at the second side 5. Thus, as input coupling device, the prism 7 firstly ensures input coupling of light at an angle that enables total-internal reflection at the second side 5 and additionally offers two faces, specifically the input coupling face 8 and the reflective face 9, for aberration correction. In contrast to the variant in FIGS. 4 and 5, the input coupling face 8 is concavely curved.

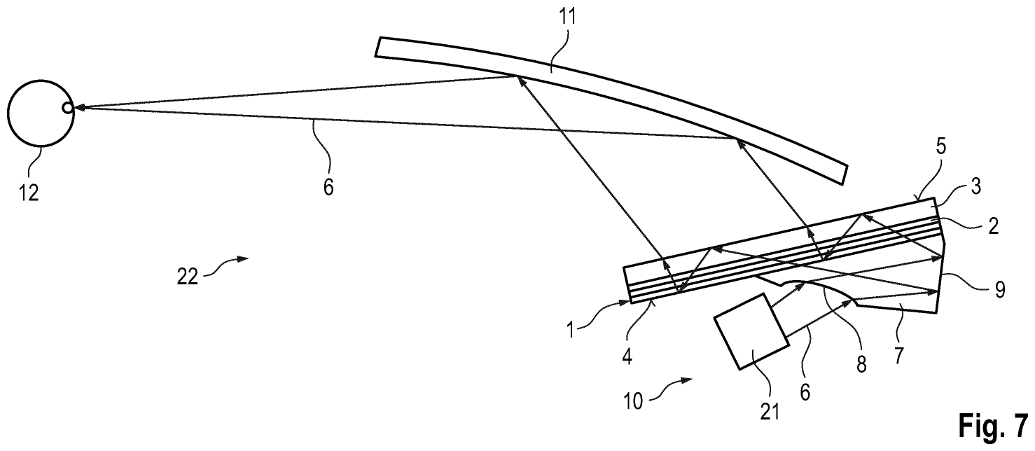

The variant shown in FIG. 7 differs from the variant shown in FIG. 6 merely in terms of the geometric arrangement of the picture generating unit 21 and the prism 7 in relation to the projection area 11. While, in FIG. 6, light is input coupled into the prism 7 coming from the right and reflected at a reflection face 9 arranged at the left, light in FIG. 7, as a result of the picture generating unit 21, is input coupled into the prism through the input coupling face 8 from the left and is reflected at a reflective face 9 arranged at the right.

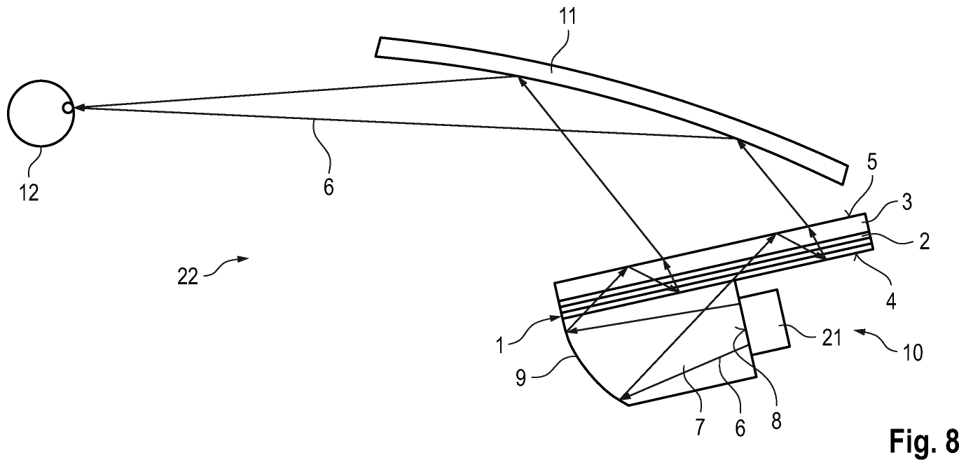

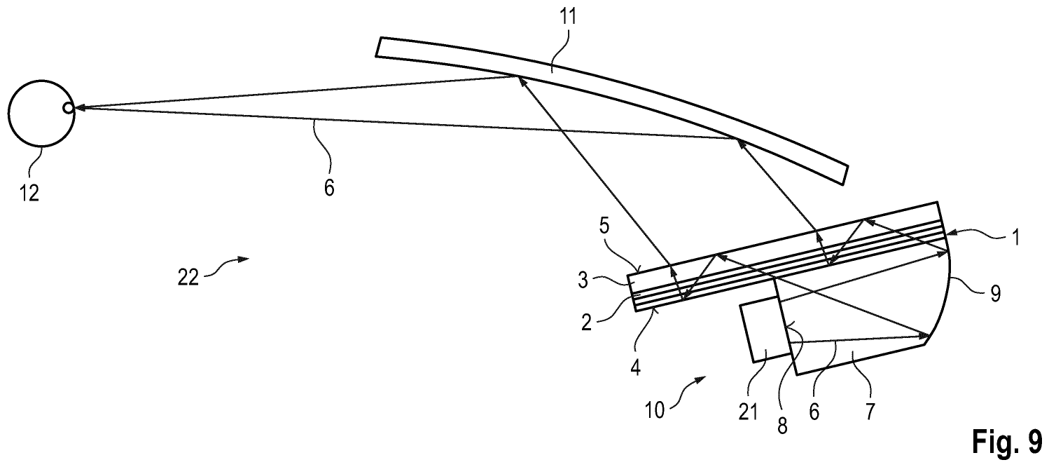

In the embodiment variants shown in FIGS. 8 and 9, the picture generating unit 21 is arranged directly on an input coupling face 8 of the prism 7. In other words, no optically effective further component or component part is arranged between the picture generating unit 21 and the input coupling face 8 of the prism 7. The input coupling face 8 can be embodied as a plane face in this variant. Opposite the input coupling face 8, the prism 7 comprises a reflectively configured face 9, for example in the form of a layer. In a manner analogous to the embodiment variants shown in FIGS. 6 and 7, this reflective face 9 is configured to guide light input coupled into the prism 7 in the direction of the second side 5 for total-internal reflection there. In contrast to the variants shown in FIGS. 6 and 7, the reflective face 9 in FIGS. 8 and 9 has a curved configuration, for example is configured as a curved freeform face. While, in FIG. 8, the picture generating unit 21 radiates light into the prism 7 coming from the right and said light is reflected by the reflecting face 9 from the left in the direction of the second face 5, light in FIG. 9, by means of the picture generating unit 21, is input coupled into the prism 7 to the right and reflected to the left in the direction of the second face 5 by means of the reflection face 9.

In the examples shown, the light undergoes total-internal reflection once within the optical element 3. In principle, a plurality of total-internal reflections are also possible within the optical element. However, only one total-internal reflection is advantageous in that no further aberrations are caused by the single beam deflection.

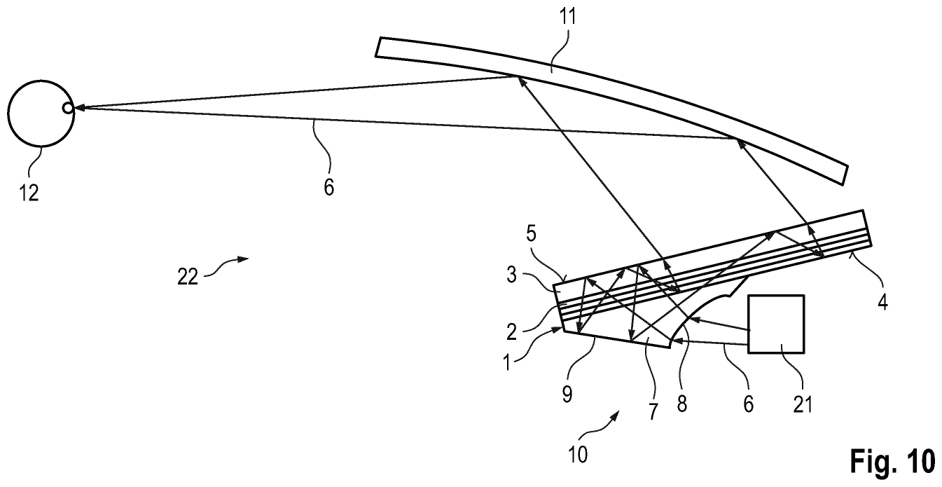

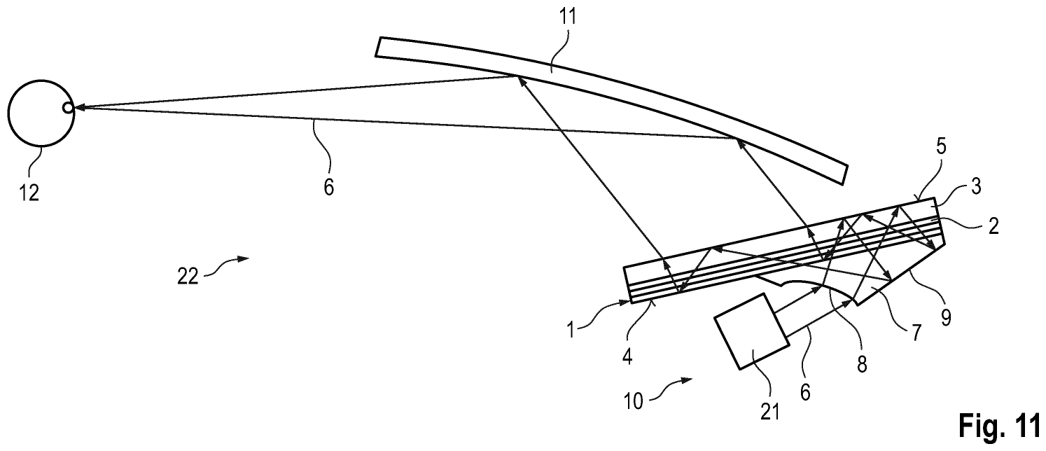

Below, FIGS. 10 and 11 are used to describe alternative configuration variants to the examples shown in FIGS. 6 and 7. In contrast to the examples of FIGS. 6 and 7, the light beams input coupled via the input coupling face 8 are transmitted by the holographic arrangement 2 in the direction of the reflective element 9 after the first total-internal reflection at the second side 5, said light beams are reflected by said reflective element, subsequently transmitted by the holographic arrangement 2 in the direction of the second side 5 and reflected by the holographic arrangement 2 after a second total-internal reflection at the second side 5. The input coupling face 8 and/or the reflective element 9 can be designed for aberration correction. By preference, these are designed such that they interact for correcting aberrations. For example, they can be formed as freeform faces and/or comprise at least one hologram. This configuration offers the advantages of installation space reduction and improved correction of imaging aberrations.

In all the above-described examples and variants, a plurality of faces and/or elements of the prism can be designed such that they interact for aberration correction. Furthermore, the prism and the holographic arrangement can be designed such that they interact for aberration correction. For example, the input coupling face and/or a reflective element of the prism and/or the holographic arrangement can be formed to interact for aberration correction.

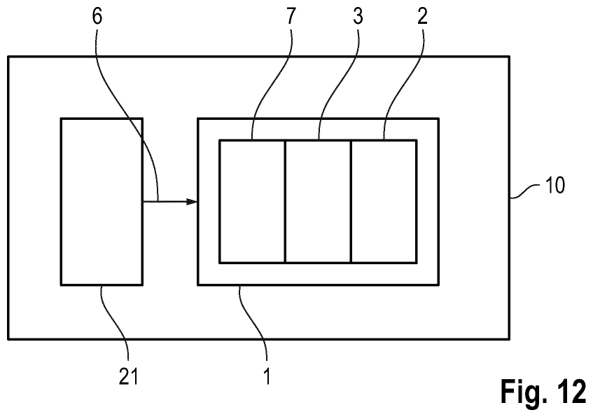

FIG. 12 schematically shows an optical arrangement 10 with a wavefront manipulator 1 in the form of a block diagram. The optical arrangement 10 comprises a picture generating unit 21 and a wavefront manipulator 1, which are arranged one behind another in a beam path 6. The wavefront manipulator 1 comprises a holographic arrangement 2 already described and an optical element 3 comprising an input coupling device 7.

### LIST OF REFERENCE SIGNS

1 Wavefront manipulator
2 Holographic arrangement
3 Optical element
4 First side/underside
5 Second side/top side
6 Beam path
7 Input coupling device
8 Input coupling face
9 Reflective element
10 Optical arrangement
11 Projection area
12 Eyebox
21 Picture generating unit
22 Head-up display
23 Further optical element

1-19. (cancelled)

20. A wavefront manipulator, comprising:
a holographic arrangement; and
an optical element that radiates light waves onto the holographic arrangement, the optical element comprising at least one face providing total-internal reflection for a defined angle of incidence range,
wherein the holographic arrangement comprises at least one reflection hologram that reflects light waves radiated onto the holographic arrangement via the optical element, and
wherein the optical element comprises an input coupling device comprising at least one prism and serving to input couple light waves into the wavefront manipulator.

21. The wavefront manipulator of claim 20, wherein the holographic arrangement is arranged in the beam path downstream of the optical element or is arranged in the beam path such that it transmits light waves in the beam path immediately downstream of the input coupling device and reflects light waves behind the surface providing total-internal reflection.

22. The wavefront manipulator of claim 20, wherein the wavefront manipulator is configured as a transmission component.

23. The wavefront manipulator of claim 20, wherein the input coupling device comprises a plurality of prisms.

24. The wavefront manipulator of claim 23, wherein the plurality of prisms are arranged as a microprism array.

25. The wavefront manipulator of claim 20, wherein the optical element comprises a first side and a second side opposite the first side, the input coupling device and the holographic arrangement being arranged on the first side and the face providing total-internal reflection being arranged on the second side.

26. The wavefront manipulator of claim 20, wherein the face providing total-internal reflection comprises an output coupling region.

27. The wavefront manipulator of claim 20, wherein the wavefront manipulator comprises an output coupling region which at least in part encompasses the face providing total-internal reflection, the input coupling device and the output coupling region overlapping at least in part in a direction perpendicular to a surface normal of the face providing total-internal reflection.

28. The wavefront manipulator of claim 20, wherein the optical element is configured such that light waves experience a fixed number n of total-internal reflections within the optical element between the input coupling device and the holographic arrangement.

29. The wavefront manipulator of claim 20, wherein the holographic arrangement comprises at least one reflection hologram, which is configured to reflect a plurality of wavelengths, or comprises a plurality of reflection holograms which are each configured for at least one wavelength of light of a color in a color space.

30. The wavefront manipulator of claim 20, wherein the holographic arrangement is arranged immediately on the optical element or is integrated in the optical element.

31. The wavefront manipulator of claim 20, wherein the holographic arrangement comprises at least one reflection hologram which is arranged on a face of the optical element opposite the face providing total-internal reflection and which reflects light waves at an angle of incidence greater than the limit angle for total-internal reflection of the face providing total-internal reflection.

32. The wavefront manipulator of claim 20, wherein the at least one prism comprises an input coupling face serving to input couple light waves into the prism and configured as a plane face or curved face or aspherical face or as a freeform face.

33. The wavefront manipulator of claim 20, wherein the wavefront manipulator comprises a further optical element.

34. The wavefront manipulator of claim 33, wherein the at least one prism comprises an input coupling face for input coupling light waves into the prism, and the further optical element is formed as a reflection layer on a face of the prism in the beam path between the input coupling face of the prism and the face providing total-internal reflection.

35. The wavefront manipulator of claim 20, wherein the optical element, the holographic arrangement and the at least one prism are formed in one piece as a monolithic component or are securely connected to one another to form a component.

36. An optical arrangement, comprising:
a picture generating unit; and
the wavefront manipulator of claim 20.

37. The optical arrangement of claim 36, wherein the picture generating unit is arranged immediately on a face of the at least one prism.

38. A head-up display, comprising:
a projection surface; and
the optical arrangement of claim 36.
